(19) United States
(12) Patent Application Publication
(10) Pub. No.: US 2024/0201505 A1
(43) Pub. Date: Jun. 20, 2024

(54) PIVOT HINGED HEAD-MOUNTED DISPLAY DEVICE

(71) Applicant: Microsoft Technology Licensing, LLC, Redmond, WA (US)

(72) Inventor: Weston Taylor SKYE, Mountain View, CA (US)

(73) Assignee: Microsoft Technology Licensing, LLC, Redmond, WA (US)

(21) Appl. No.: 18/194,247

(22) Filed: Mar. 31, 2023

Related U.S. Application Data
(60) Provisional application No. 63/476,343, filed on Dec. 20, 2022.

(51) Int. Cl. G02B 27/01; F16M 13/04

(52) U.S. Cl. CPC G02B 27/0176; F16M 13/04; G02B 2027/0159; G02B 2027/0169

(57) ABSTRACT

Examples are disclosed that relate to single and double pivot hinge assemblies for an HMD device. One example provides an HMD device comprising a wearable support configured to be worn on a head of a user. The HMD device further comprises a head-up display mounted to the wearable support by a hinge assembly. The hinge assembly comprises a mounting component connected to the wearable support, and a bar connected to the mounting component at a first pivot. The bar is further connected to the head-up display at a second pivot.

### CROSS REFERENCE TO RELATED APPLICATIONS

This application claims priority to U.S. Provisional Application Ser. No. 63/476,343 entitled PIVOT HINGED HEAD-MOUNTED DISPLAY DEVICE, filed Dec. 20, 2022, the entirety of which is hereby incorporated herein by reference for all purposes.

### BACKGROUND

Head-mounted display (HMD) devices may be used to present graphical content within the context of augmented reality (AR) (including mixed reality (MR)) and virtual reality (VR) user experiences. HMD devices may be mounted to a wearable support such as a helmet, hat, visor, headband, or other head covering. Some HMD devices may be mounted to wearable supports via a hinge that enables a display device of the HMD device to be moved into and out of the line of sight of the user. HMD devices may feature adjustment mechanisms that enable adjustment of a positioning of the display device of the HMD device relative to the eyes of the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to single and double pivot hinge assemblies for an HMD device. One example provides an HMD device comprising a wearable support configured to be worn on a head of a user. The HMD device further comprises a head-up display mounted to the wearable support by a hinge assembly. The hinge assembly comprises a mounting component connected to the wearable support, and a bar connected to the mounting component at a first pivot. The bar is further connected to the head-up display at a second pivot.

### BRIEF DESCRIPTION OF THE DRAWINGS

FIG. 1 schematically depicts an example HMD device utilizing a hinge assembly with two pivots and two bars.

FIG. 2 schematically depicts an example translational adjustment of the HMD device of FIG. 1.

FIG. 3 schematically depicts an example angular adjustment of the HMD device of FIG. 1.

FIG. 4 schematically depicts the HMD device of FIG. 1 in an example stowed position.

FIG. 5 schematically depicts an example HMD device utilizing a hinge assembly with a single pivot.

FIGS. 6-7 schematically depict example transitional adjustments of the HMD device of FIG. 5.

FIG. 8 schematically depicts an example angular adjustment of the HMD device of FIG. 5.

FIG. 9 schematically depicts the HMD device of FIG. 5 in an example stowed position.

FIG. 10 schematically depicts an example hinge assembly for the HMD device of FIG. 5.

FIGS. 11-15 depict an example eccentric rotational bracket.

FIG. 16 depicts an example friction mechanism.

FIG. 17 depicts another example friction mechanism.

FIG. 18 depicts an example detent mechanism.

FIGS. 19-20 schematically depict an example HMD device with two pivots traveling through a transition point.

FIG. 21 depicts an example cam mechanism for a pivot to provide a variable torque resistance.

FIG. 22 depicts an example hinge assembly utilizing a single bar and two pivots.

FIG. 23 depicts an example first pivot of the hinge assembly of FIG. 22.

FIG. 24 depicts an example second pivot of the hinge assembly of FIG. 22.

FIG. 25 schematically depicts an example torque profile of the first pivot of FIG. 23.

FIG. 26 depicts an example adjustable stopper used by the hinge assembly of FIG. 22.

FIG. 27 depicts an example pivot utilizing a tilt mechanism.

FIG. 28 depicts another view of the tilt mechanism of FIG. 27.

### DETAILED DESCRIPTION

As mentioned above, HMD devices may be used to present graphical content within the context of AR and VR user experiences. HMD devices may be mounted to a wearable article such as a helmet, hat, visor, headband, or other head coverings. Some HMD devices may be mounted to wearable articles using a hinge that enables a display device of the HMD device to be moved into and out of the line of sight of the user. HMD devices may feature adjustment mechanisms that enable adjustment of a positioning of the display device of the HMD device relative to the eyes of the user.

A potential disadvantage of HMD devices that feature a hinge is that the display device extends outward and away from the head of the user. As an example, some HMD devices feature a hinge that enables rotation of the display device forward and outward to a horizontal position above and forward of the eyes of the user. In this configuration, the mass of the display device also extends forward and outward from the head of the user. As a center of mass of the display device moves further away from the head of the user, particularly in a horizontal dimension orthogonal to the gravity vector, forces experienced by the user (e.g., torque at the neck of the user) may be increased due to mechanical advantage. These added forces may be more pronounced from the perspective of the user in scenarios where the head of the user is experiencing acceleration, such as during walking, running, movement of the head, vehicle transport, etc. Furthermore, changes in inertial response caused by repositioning of the display device of the HMD device may impede natural movement and control of head motion by the user, particularly where the center of mass of the display device extends outward in a horizontal dimension orthogonal to the gravity vector.

Accordingly, examples are disclosed that relate to HMD devices that comprise single and double pivot hinge assemblies. Briefly, an HMD device comprises a wearable support and a head-up display mounted to the wearable support by a hinge assembly. The wearable support is configured to be worn on a head of a user. The hinge assembly includes a mounting component connected to the wearable support. A first bar is connected to the mounting component at a first pivot. Further, a second bar is attached to the first bar at a second pivot and attached to the head-up display.

In another example, the hinge assembly includes a mounting component connected to the wearable support. A bar is connected to the mounting component at a pivot and connected to the head-up display. Further, a first adjustment mechanism allows a position of the pivot relative to the wearable support to be adjusted. A second adjustment mechanism allows a position of the head-up display relative to the bar to be adjusted.

In yet another example, the hinge assembly includes a mounting component connected to the wearable support. A bar is connected to the mounting component at a first pivot and connected to the head-up display at a second pivot.

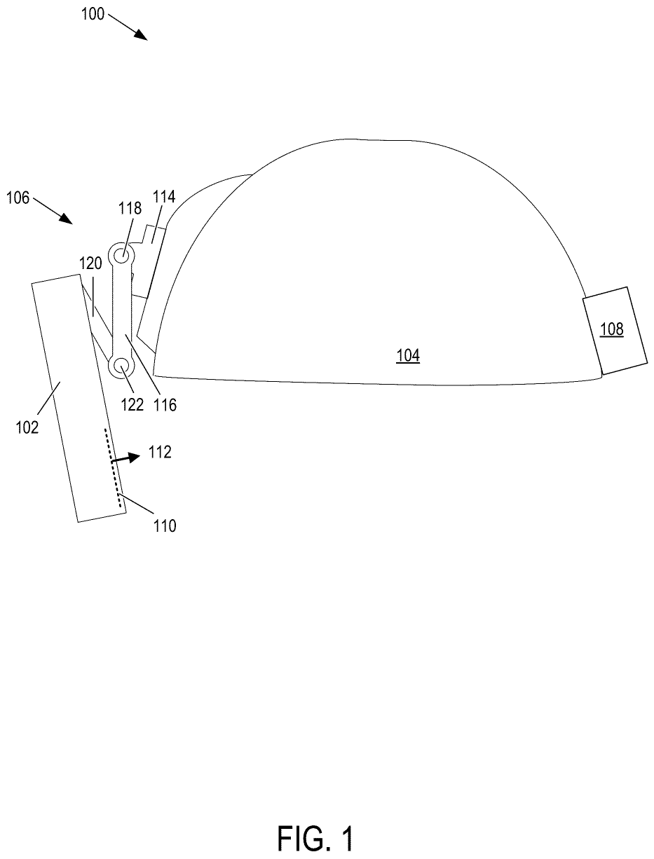

FIG. 1 depicts an example HMD device 100 including a head-up display 102 that is mounted to a wearable support 104 by a hinge assembly 106. Hinge assembly 106 of FIG. 1 is one example of the disclosed hinge assembly in a deployed position. Wearable support 104 is configured to be worn on a head of a user. In the current example, wearable support 104 is depicted as a helmet. In other examples, wearable support 104 may take any other suitable form, such as a hat, visor, headband, or other head coverings. HMD device 100 further includes a counterweight 108 to help balance a load on the head of the user from various components of HMD device 100.

Head-up display 102 comprises a near-eye display by which graphical content can be presented. Head-up display 102 may include additional components, including cameras, sensors, user input interfaces, audio output devices, batteries, computing devices, electronic circuitry, etc. It will be understood that head-up display 102 may take other suitable forms. In some examples, head-up display 102 may be connected to other computing devices using one or more cables. A display plane 110 of head-up display 102 is represented schematically along with an example display vector 112 to illustrate a general direction of light emitted by head-up display 102. As an example, within the deployed position of FIG. 1, display vector 112 is generally directed at a location of the eyes of the user.

Hinge assembly 106 includes a mounting component 114 connected to wearable support 104. In other examples, mounting component 114 may be integrated with, mounted to, or mountable to wearable support 104. A first bar 116 is connected to mounting component 114 at a first pivot 118. Further, a second bar 120 is attached to first bar 116 at a second pivot 122 and attached to head-up display 102. First pivot 118 and second pivot 122 enable movement of head-up display 102 relative to wearable support 104.

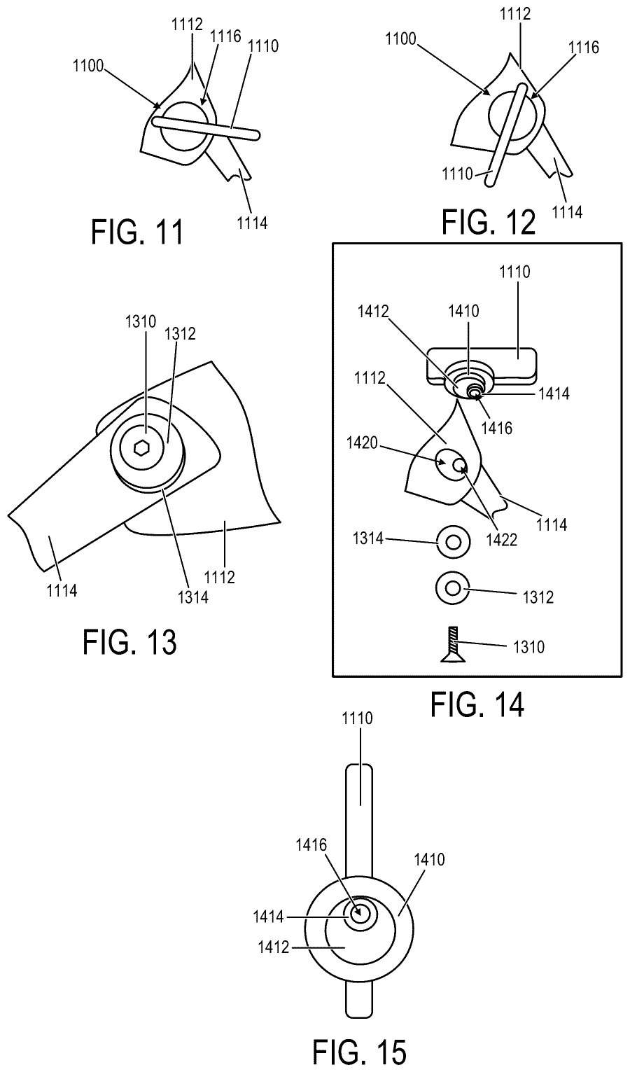

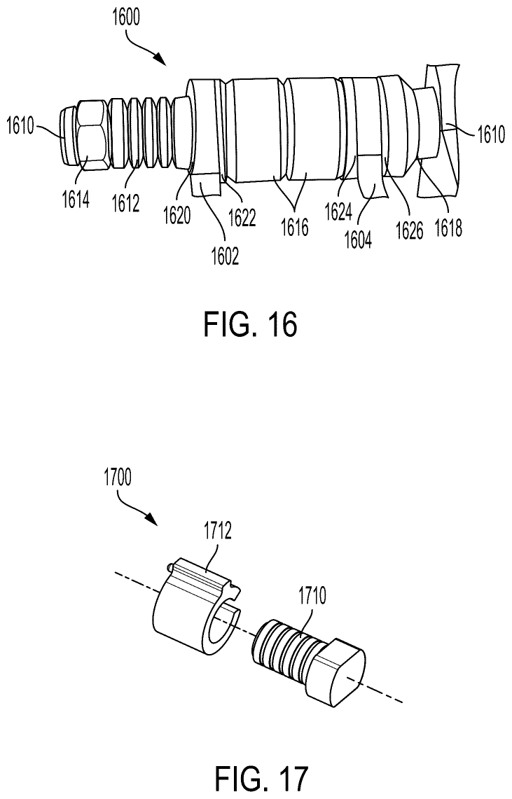

First pivot 118 and/or second pivot 122 can comprise an eccentric rotational bracket in some examples. An example of the eccentric rotational bracket is described in further detail with reference to FIGS. 11-15. Alternatively or additionally, first pivot 118 and/or second pivot 122 can comprise one or more hard-stop mechanisms, detent mechanisms, and/or friction mechanisms to restrict angular movement of the corresponding pivot and assist in maintaining a current state or positioning of hinge assembly 106 during user activities that include walking, running, and/or movement of the head. As a more specific example, the restriction of angular movement of the corresponding pivot can be configured in view of user movement through an obstacle course. Friction mechanisms, such as an adjustable torque resistance, may be tuned or otherwise selected to provide a particular level of friction at first pivot 118 and/or second pivot 122, thereby defining a suitable level of torque needed to overcome the friction introduced by the friction mechanism(s) when adjusting a positioning of head-up display 102 relative to mounting component 114 using hinge assembly 106. The friction mechanisms may be tuned using a screw, lever, clamp (e.g., shaft collar or swing) or other suitable mechanisms. As an example, a suitable level of torque may be defined so that head-up display 102 does not rotate using hinge assembly 106 relative to mounting component 114 under its own weight. As another example, a suitable level of torque may be defined so that head-up display 102 does not rotate using hinge assembly 106 relative to mounting component 114 under specified dynamic loading scenarios such as head movement (e.g., nodding), walking, running, jumping, etc. In some such examples, the suitable level of torque may be defined so that head-up display 102 does not rotate using hinge assembly 106 relative to mounting component 114 when the user is navigating an obstacle course. Examples of friction mechanisms that can be integrated into first pivot 118 and/or second pivot 122 are described in further detail with reference to FIGS. 16 and 17.

Hinge assembly 106 can further have optional locking features integrated with first pivot 118 and/or second pivot 122. As one example, the specified pivot can include interlocking features (e.g., teeth) to restrict angular movement of the specified pivot when engaged. The interlocking features may be engaged/disengaged using a push-button, a lever, or any other suitable mechanism. The interlocking features may be disengaged, the specified pivot rotated so that head-up display 102 is in a desired location, and then the interlocking features may be engaged. In such a manner, head-up display 102 can be adjusted when desired, and further may not move under its own weight after being adjusted. Alternatively or additionally, the specified pivot can comprise one or more adjustable detents and/or hard-stop mechanisms to restrict angular movement of the specified pivot, such as in the deployed position. As an example, a user may adjust head-up display 102 to a desired deployed position, then adjust the adjustable detents relative to the specified pivot such that the adjustable detents hold the specified pivot in position to support head-up display 102 at the desired deployed position. In such a manner, different users may set the adjustable detents to different desired deployed positions of head-up display 102 and may help to enable a more repeatable location after several movements of head-up display 102. Further, the adjustable detents and/or hard-stops may be adjusted using an angular adjustment mechanism that adjusts a location of an angle of the adjustable detent and/or hard-stop. Examples of angular adjustment mechanisms include a thumb screw, a lever, or other suitable mechanism.

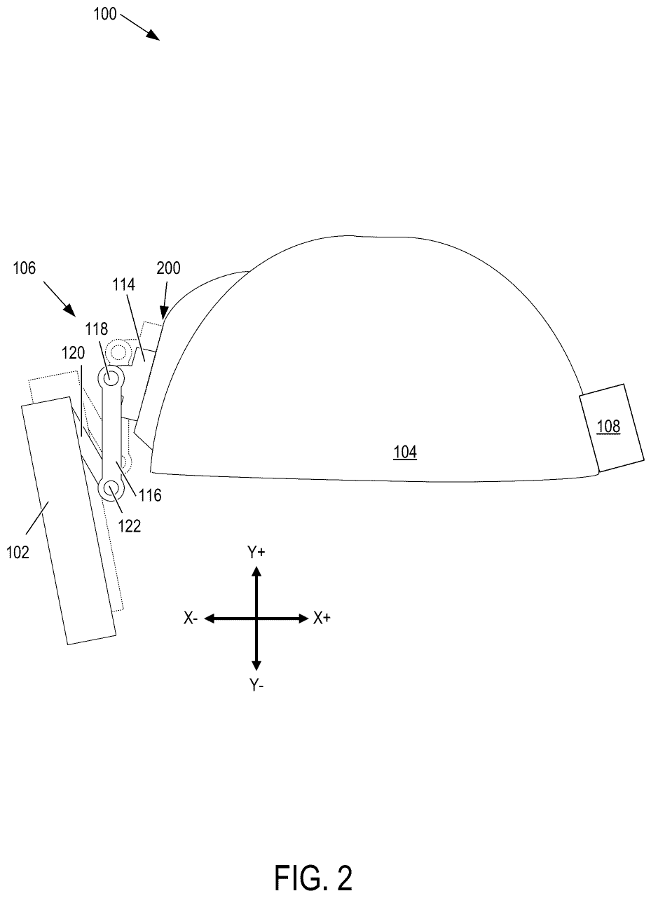

In some examples, head-up display 102 may be configured to accommodate a greater range of positions than can be provided by first pivot 118 and second pivot 122. Thus, FIG. 2 illustrates an adjustment mechanism 200 for hinge assembly 106. Adjustment mechanism 200 allows a position of first pivot 118 relative to mounting component 114 to be adjusted. In this example, adjustment mechanism 200 enables an adjustment in a generally vertical direction by translation of first pivot 118 relative to mounting component 114. Such an adjustment may help to align head-up display 102 with the eyes of different users. In some examples, adjustment mechanism 200 can include interlocking features (e.g., teeth) to help restrict movement of adjustment mechanism 200. The interlocking features can be disengaged by squeezing a push-button. When head-up display 102 is in a desired position, the push-button can be released to engage the interlocking features, thereby locking adjustment mechanism 200 in place. In other examples, adjustment mechanism 200 can include a rail-track. A control lever or cam, as examples, may be used to create friction between the rail-track and first pivot 118. Specifically, the control lever can release the rail-track to allow movement of first pivot 118. Further, when head-up display 102 is in the desired position, the control level can be engaged to add friction between first pivot 118 and the rail-track, thereby restricting translational movement of first pivot 118 relative to mounting component 114. In various examples, a cross-section of the rail-track can comprise one or more of a rectangle shape or trapezoid shape (e.g., dovetail). It will be understood that other suitable adjustment mechanisms may be used.

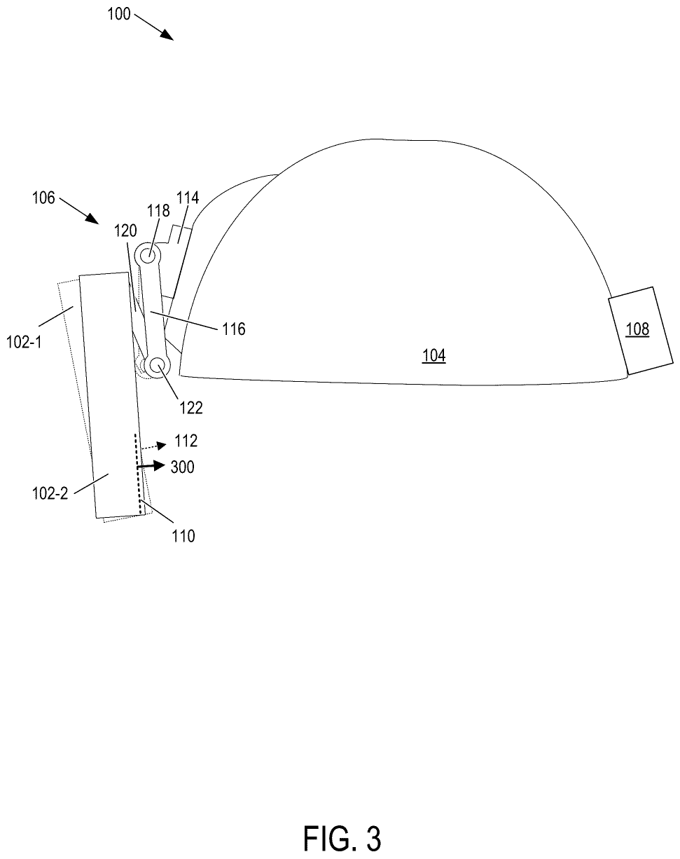

A user of HMD device 100 may use head-up display 102 in different postures, such as a standing posture and a prone posture. In the standing posture, HMD device 100 can be used in a first deployed position. In the prone posture, the neck and head of the user are tilted rearward relative to the body. As such head-up display 102 can be positioned in a second deployed position for viewing head-up display 102 when the user is in the prone posture. FIG. 3 schematically depicts an example angular adjustment of head-up display 102 between a first deployed position and a second deployed position. As shown, head-up display 102-1 is in the first deployed position, generally corresponding to the user in the upright posture. An angle of first pivot 118 and/or second pivot 122 is adjusted such that head-up display 102-2 is in the second deployed position, generally corresponding to the user in the prone posture. Even with such rotation of head-up display 102 and display plane 110, a display vector 300 remains directed generally toward the user, thereby maintaining light security with respect to light emitted by the display device.

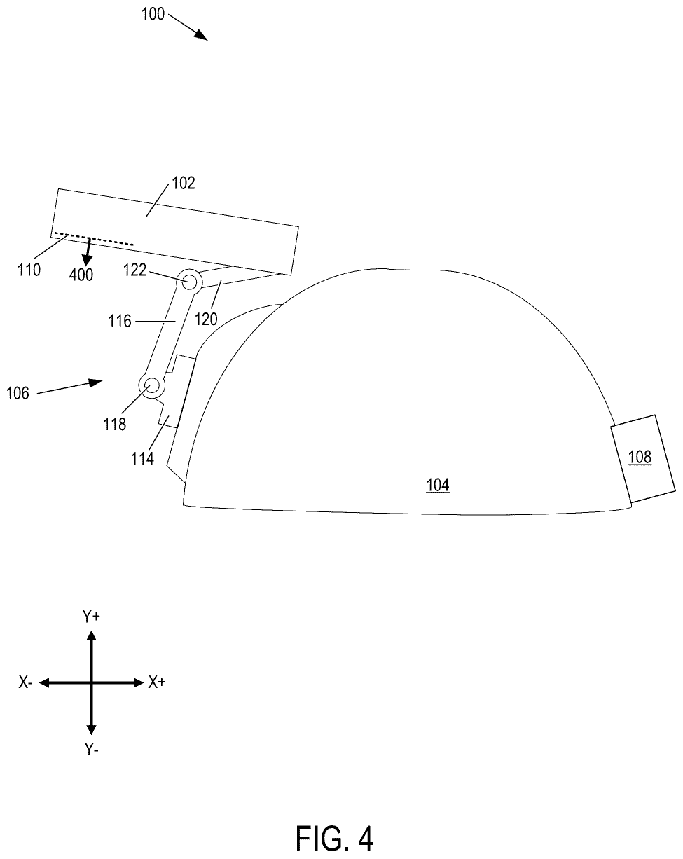

When head-up display 102 is not engaged, head-up display 102 can be moved out of a line-of-sight of the user and into a stowed position, as shown in FIG. 4. In the current example, head-up display 102 is rotated upward and rearward from the deployed position of FIG. 1 to the stowed position of FIG. 4. In some examples, first pivot 118 and/or second pivot 122 can comprise one or more mechanisms to maintain hinge assembly 106 in the stowed position similar to the mechanisms used to maintain head-up display 102 in the deployed position. In some examples, first pivot 118 and/or second pivot 122 may employ detents to maintain head-up display 102 in the stowed position. The detents may maintain the stowed position more securely than using friction mechanisms. In the stowed position of FIG. 4, head-up display 102 is positioned above and along an upper portion of wearable support 104. The stowed position of FIG. 4 locates a center of mass of head-up display 102 above the head of the user wearing HMD device 100, thereby reducing forces (e.g., torque) on the user that may otherwise result if the center of mass of the head-up display were cantilevered further outward and forward of wearable support 104.

In FIG. 4, a normal vector 400 to the display plane 110 (“display vector 400”) is directed generally downwardly in the depicted stowed position thereby helping to maintain light security with respect to light emitted by head-up display 102. Further, the generally downward direction of display vector 400 may help to prevent exposure of optical components of head-up display 102 to overhead obstacles, such as tree branches, for example, and thus, may help to reduce damage to the optical components over a stowed position with a display vector in a generally X-axis dimension and/or positive Y-direction.

Hinge assembly 106 as used by HMD device 100 enables adjustments of head-up display 102 with three degrees of freedom. Specifically, first pivot 118 and second pivot 122 help to enable a horizontal adjustment (e.g., towards/away from a face of the user) and a tilt adjustment. Further, adjustment mechanism 200 helps to enable a vertical adjustment of head-up display. Such adjustability helps to position head-up display 102 for different users and helps to view head-up display 102 when the user is in different postures, such as a prone posture. Further, hinge assembly 106 may be simpler than previous designs and as such, may have reduced weight and/or increased robustness.

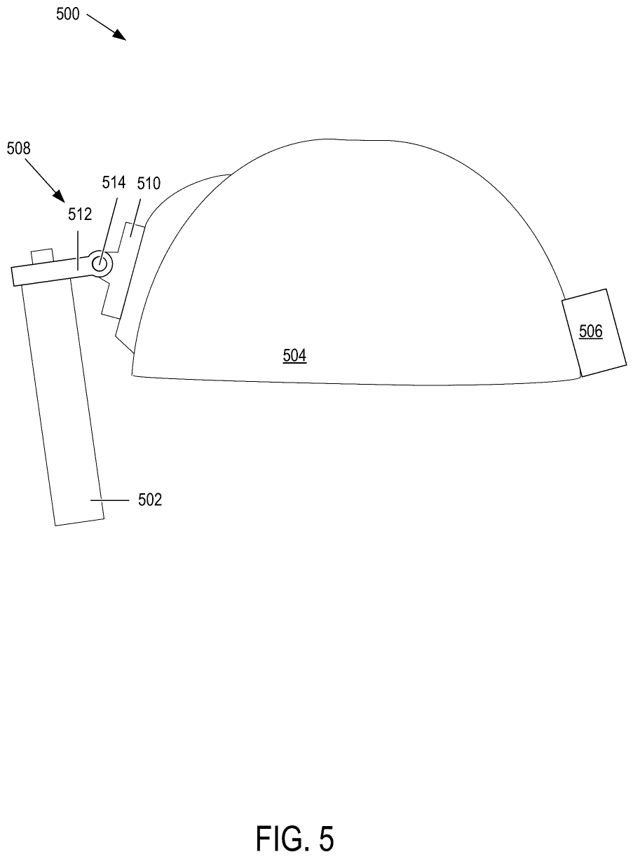

In the above examples, the hinge assembly includes a double pivot configuration. In other examples, a hinge assembly can include a single pivot, as schematically depicted in FIG. 5. Similar to HMD device 100, example HMD device 500 includes a head-up display 502 that is mounted to a wearable support 504 by a hinge assembly 508. Also, HMD device 500 includes a counterweight 506. Hinge assembly 508 of FIG. 5 is shown in a deployed position. Hinge assembly 508 includes a mounting component 510 connected to wearable support 504. Hinge assembly 508 further includes a bar 512 connected to mounting component 510 at a pivot 514. Bar 512 also is connected to head-up display 502. As described above, pivot 514 can include one or more detents, a friction mechanism, interlocking features, and other structures described above.

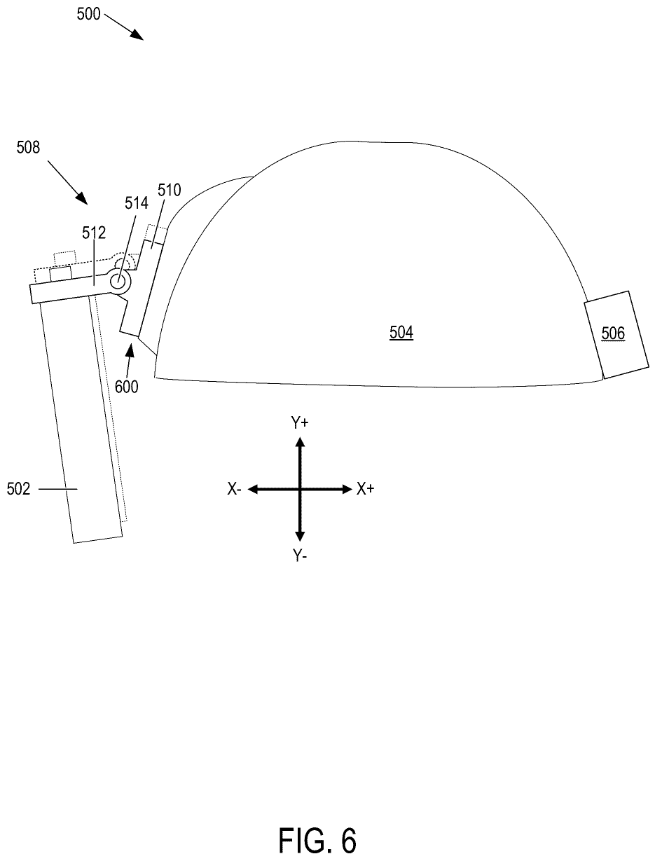

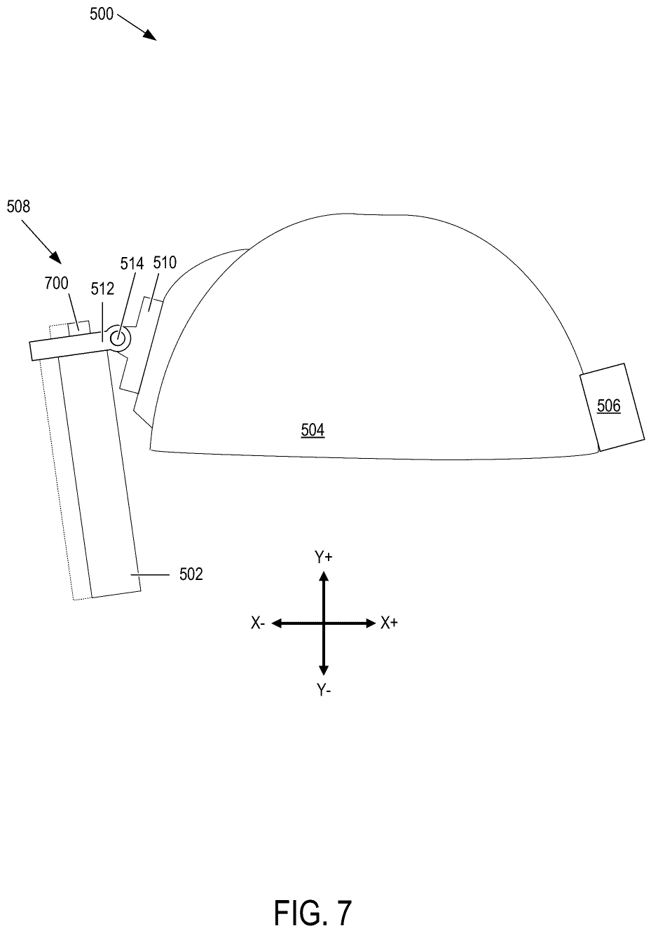

Hinge assembly 508 further includes a first adjustment mechanism 600 to adjust a position of pivot 514 relative to mounting component 510, as shown in FIG. 6. In this example, first adjustment mechanism 600 enables an adjustment in a generally vertical direction by translation of pivot 514 relative to mounting component 510. Such an adjustment may help to align head-up display 502 with the eyes of the user. First adjustment mechanism 600 can be configured in any manner as disclosed herein. Similarly, hinge assembly 508 further includes a second adjustment mechanism 700 to adjust a position of head-up display 502 relative to bar 512 as schematically depicted in FIG. 7. In the current example, second adjustment mechanism 700 enables an adjustment in a generally horizontal direction by translation of head-up display 502 relative to bar 512. Second adjustment mechanism 700 is depicted as a knob. The knob can be a screw knob, a push button, a pull knob or another suitable mechanism that engages with interlocking features or a rail-track as described herein. It will be understood that other suitable adjustment mechanisms than a knob may be used for first adjustment mechanism 600 and/or second adjustment mechanism 700.

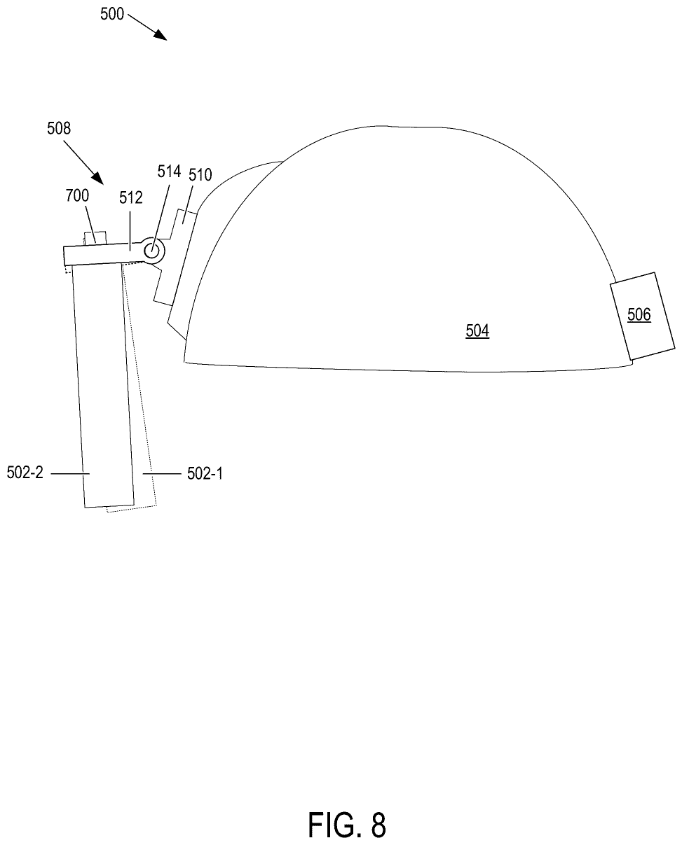

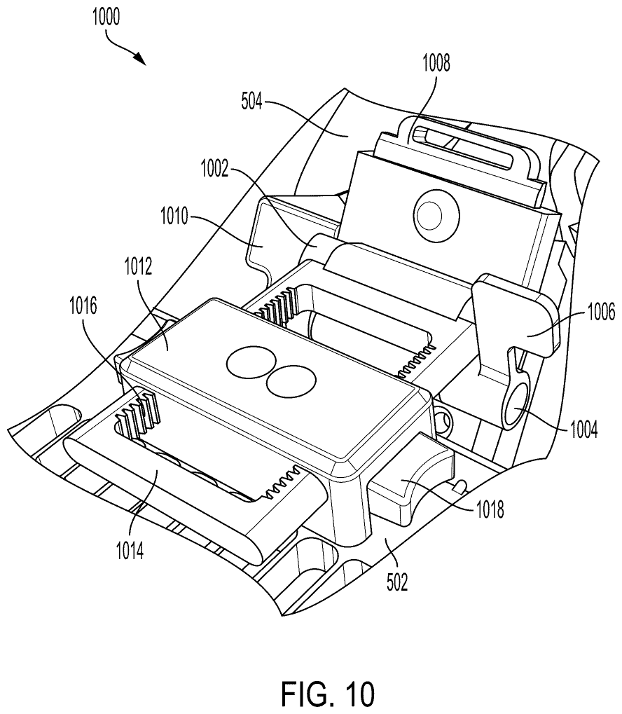

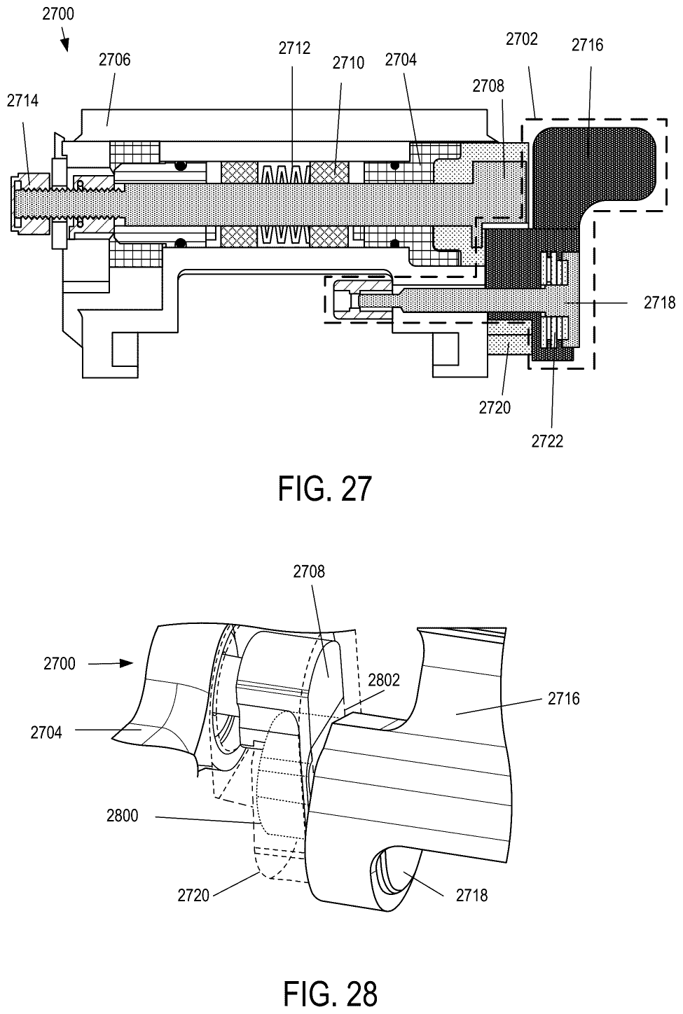

Similar to HMD device 100, HMD device 500 may be worn by the user in an upright posture or a prone posture. As such, FIG. 8 schematically depicts an example angular adjustment of head-up display 502 moving from a first deployed position (e.g., 502-1) for upright use to a second deployed position (e.g., 502-2) for prone use. In some examples, the angular adjustment of hinge assembly 508 can use a same control mechanism as pivot 514. In other examples, the angular adjustment may utilize a separate control mechanism than pivot 514 and/or a second pivot. An example of a separate pivot to switch between the first and second deployed positions is discussed with reference to FIG. 10. A further example of a separate control mechanism for the angular adjustment of a pivot is discussed with reference to FIGS. 27-28.

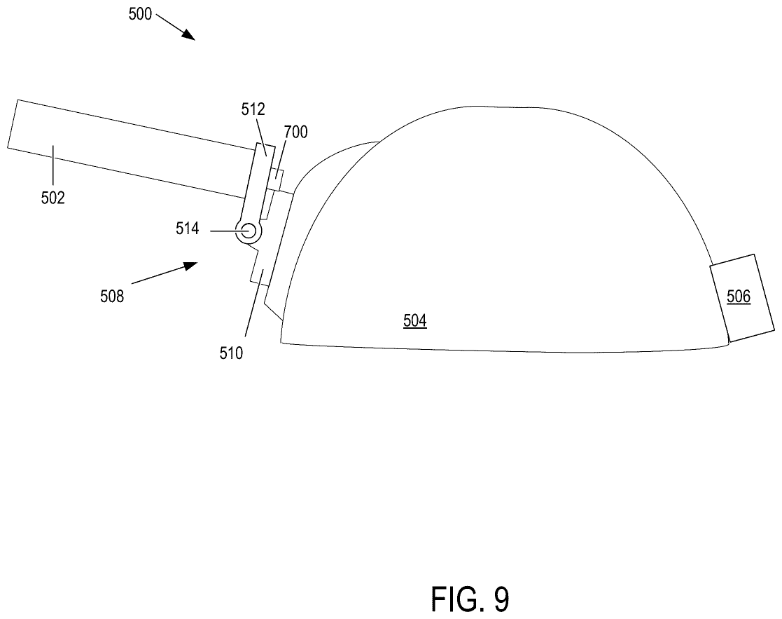

When head-up display 502 is not engaged, head-up display 502 can be moved out of a line-of-sight of the user and into a stowed position, as schematically shown in FIG. 9. In the current example, head-up display 502 is rotated upward from the deployed position of FIG. 5 to the stowed position of FIG. 9. In some examples, pivot 514 can comprise one or more suitable mechanisms to maintain hinge assembly 508 in the stowed position similar to the mechanisms used to maintain head-up display 502 in the deployed position, such as detents, for example.

FIG. 10 illustrates an example hinge assembly 1000 that can be used with HMD device 500. Hinge assembly 1000 includes a first pivot 1002 that allows movement between a stowed position of head-up display 502 and a deployed position of head-up display 502. First pivot 1002 may take any suitable form as described herein. Further, hinge assembly comprises a second pivot 1004 that allows movement between a first deployed position and a second deployed position, such as for use in an upright posture and a prone posture, for example. In the current example, second pivot 1004 is integrated with a tilting lever 1006 for controlling the movement between the first deployed position and the second deployed position. Second pivot 1004 and tilting lever 1006 can use an eccentric cam, or a pin in a centric slot, or other mechanisms to restrict angular movement of second pivot 1004 between the first deployed position and the second deployed position.

Hinge assembly 1000 further comprises a first adjustment mechanism 1008 that allows a position of first pivot 1002 relative to a mounting component 1010 to be adjusted as described herein. A second adjustment mechanism 1012 enables a position of head-up display 502 relative to a bar 1014 to be adjusted. As shown, bar 1014 comprises interlocking features 1016 (depicted as teeth in FIG. 10). Second adjustment mechanism 1012 includes corresponding interlocking features to interlocking features 1016. In this example, a push-button 1018 is squeezed to disengage the interlocking features of second adjustment mechanism 1012 and bar 1014. When head-up display 502 is in a desired location, push-button 1018 is released and the interlocking features engaged, thereby restricting movement of head-up display 502 relative to bar 1014. FIG. 10 is illustrative and in other examples, a hinge assembly may take other forms.

FIGS. 11-15 depict an example of an eccentric rotational bracket 1100 having a viewing angle selector element 1110 that can be used for pivots of hinge assembly 106 and/or hinge assembly 508. FIGS. 11 and 12 show eccentric rotational bracket 1100 integrated with a pivot 1116 between a first bar 1112 and a second bar 1114. In FIG. 11, eccentric rotational bracket 1100 and viewing angle selector element 1110 have a first angular position that defines a first axis of rotation of pivot 1116. In FIG. 12, eccentric rotational bracket 1100 and viewing angle selector element 1110 are rotated to a second angular position relative to the first angular position of FIG. 11, which moves the axis of rotation of pivot 1116 relative to a second axis of rotation that is parallel to and displaced from the first axis of rotation.

FIG. 13 shows a rear view of eccentric rotational bracket 1100 showing a threaded fastener 1310 (e.g., a bolt or screw) and a pair of washers 1312 and 1314 of the eccentric rotational bracket.

FIGS. 14 and 15 show disassembled views of eccentric rotational bracket 1100, including a first circular bearing portion 1410 that has a circular bearing face 1412, and a second circular bearing portion 1414 that is located off-center from a center point of circular bearing face 1412. Second circular bearing portion 1414 defines a threaded receptacle that accommodates threaded fastener 1310. First circular bearing portion 1410 fits within a first opening 1420 formed in first bar 1112, and second circular bearing portion 1414 fits within a second opening 1422 formed in second bar 1114 that has a smaller diameter than first opening 1420. In this configuration, second opening 1422 is off-center from a center point of first opening 1420. Threaded fastener 1310 passes through washers 1312, 1314, and second opening 1422 and engages with threaded receptacle 1416 to secure bracket 1100 to bars 1112 and 1114.

FIG. 16 depicts an example friction mechanism 1600 that can be integrated with pivots of a hinge assembly such as those disclosed herein. Friction mechanism 1600 includes a shaft 1610 upon which a first bar 1602 and a second bar 1604 are mounted. A spring element 1612 is mounted on shaft 1610 that applies a compressive force onto first bar 1602 and second bar 1604. In this example, spring element 1612 is mounted on shaft 1610 between a first retaining element 1614 and first bar 1602, a spacer 1616 is mounted on shaft 1610 between first bar 1602 and second bar 1604, and second bar 1604 is mounted on shaft 1610 between spacer 1616 and a second retaining element 1618.

The compressive force applied to first bar 1602 by spring element 1612 generates friction to rotation of the first bar about shaft 1610 at friction interfaces 1620 and 1622. The compressive force applied to second bar 1604 by spring element 1612 generates friction to rotation of the second bar about shaft 1610 at friction interfaces 1624 and 1626. In at least some examples, the compressive force applied by spring element 1612 may be adjusted by adjusting a position (e.g., a distance) of first retaining element 1614 relative to second retaining element 1618 along shaft 1610. As an example, first retaining element 1614 may take the form of a threaded nut and shaft 1610 may have corresponding threads that enables first retaining element 1614 to be moved back and forth along an axis of shaft 1610 by rotation of the threaded nut relative to the shaft.

FIG. 17 depicts another example friction mechanism 1700 that can be integrated with a pivot of hinge assembly 106. In this example, the pivot rotates using a friction shaft 1710 of friction mechanism 1700. Friction mechanism 1700 further includes a clip 1712 through which friction shaft 1710 passes. Clip 1712 exerts a circumferential force upon friction shaft 1710. Rotation of friction shaft 1710 relative to clip 1712 generates friction at a friction interface between the friction shaft and interior surfaces of clip 1712 that interface with the friction shaft. Friction mechanism 1700 may be integrated with any pivot in which two components of a hinge assembly are rotatably coupled by fixing friction shaft 1710 to a first component, and by fixing clip 1712 to a second component.

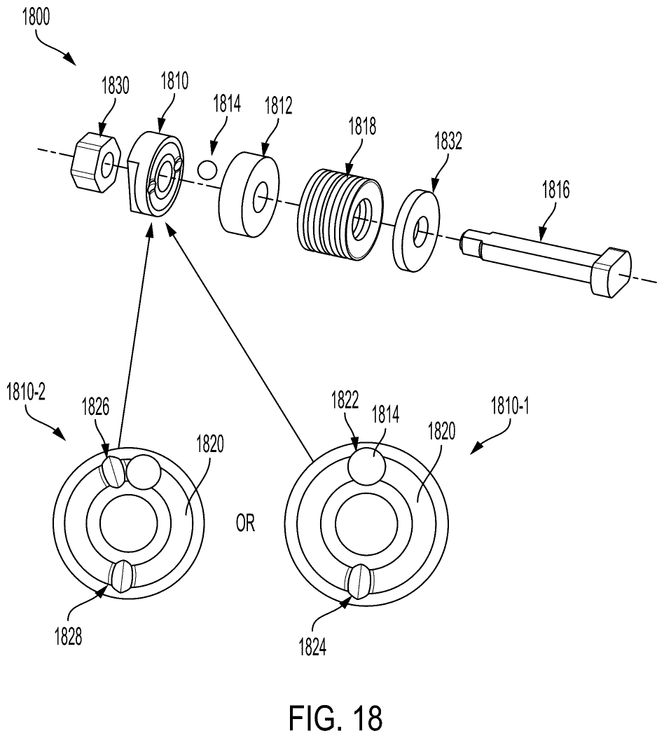

FIG. 18 depicts an example detent mechanism 1800 that can be integrated with any pivot of hinge assembly 106 and/or hinge assembly 508. Detent mechanism 1800 includes a first cam 1810 and a second cam 1812 that can rotate relative to each other on opposing sides of a ball 1814. Second cam 1812 includes a receptacle that accommodates a portion of ball 1814. Ball 1814 remains within the receptacle of second cam 1812 throughout engaged and disengaged states of detent mechanism 1800.

First cam 1810 and second cam 1812 are mounted on a pin or shaft 1816 with a disc spring 1818. First cam 1810, second cam 1812, and disc spring 1818 may be retained on shaft 1816 by a nut 1830 and a washer 1832. For example, pin or shaft 1816 can include threads that engage with corresponding threads of nut 1830. Disc spring 1818 applies a compressive force to first cam 1810 and second cam 1812 that compresses first cam 1810 and second cam 1812 onto ball 1814.

Within the context of a pivot by which two components of a hinge assembly are rotatably coupled, such as within hinge assemblies disclosed herein, first cam 1810 is fixed to or forms part of a first component, and second cam 1812 is fixed to or forms part of a second component.

First cam 1810 can take various forms, examples of which are depicted in FIG. 18 as 1810-1 and 1810-2. As an example, first cam 1810-1 can be used in an instance of detent mechanism 1800 on a first component at a pivot (e.g., 118, 122, 514, or another pivot disclosed herein), and first cam 1810-2 can be used in another instance of detent mechanism 1800 on a second component at the pivot.

First cam 1810 defines a circular track 1820 along which ball 1814 can travel. First cam 1810 further defines one or more receptacles along circular track 1820 that accommodate a portion of ball 1814 that projects outward from second cam 1812. As ball 1814 resides within a receptacle of second cam 1812, when ball 1814 also resides within a receptacle of first cam 1810, rotation of the first cam relative to the second cam about pin or shaft 1816 is inhibited, thereby providing an engaged detent function. When the compressive force provided by disc spring 1818 is overcome (e.g., by a user pulling a head of pin or shaft 1816 away from nut 1830), first cam 1810 can be rotated relative to second cam 1812, and ball 1814 is released from the receptacle of the first cam into circular track 1820, thereby disengaging the detent function.

Referring to first cam 1810-1, as an example, a first receptacle 1822 is located at a different angular position along circular track 1820 than a second receptacle 1824. For example, first receptacle 1822 may be located at 0 degrees in a radial reference frame of circular track 1820, and second receptacle 1824 may be located at 190 degrees (or another suitable angle) measured in the clockwise direction in FIG. 18. In this example, first receptacle 1822 corresponds to the first deployed position, and second receptacle 1824 corresponds to the stowed position of the head-up display.

Referring to first cam 1810-1, as another example, a first receptacle 1826 is located a different angular position along circular track 1820 as second receptacle 1828. For example, first receptacle 1822 may be located at −8 degrees (or other suitable angles) in a radial reference frame of circular track 1820, and second receptacle 1828 may be located at 190 degrees (or another suitable angle) measured in the clockwise direction in FIG. 18. In this example, first receptacle 1826 corresponds to the second deployed position, and second receptacle 1828 corresponds to the stowed position of the head-up display. First receptacle 1826 is offset 8 degrees from second receptacle 1828, in this example, to provide an 8 degree angular offset between the first and second deployed positions. It will be understood that other suitable angular offsets may be used, such as an angle in the range of 6-10 degrees, as another example. Also in this example, receptacles 1824 and 1828 are provided at the same angular position, as these receptacles each correspond to the stowed position.

The adjustment mechanisms disclosed herein enable adjustment of a positioning, in one or more degrees of freedom, of a head-up display relative to a mounting component. Such adjustment may include translation and/or rotation of the head-up display relative to the mounting component. It will be understood that the example adjustment mechanisms disclosed herein are provided for illustrative purposes as other suitable adjustment mechanisms may be used to adjust the positioning of the head-up display relative to the mounting component.

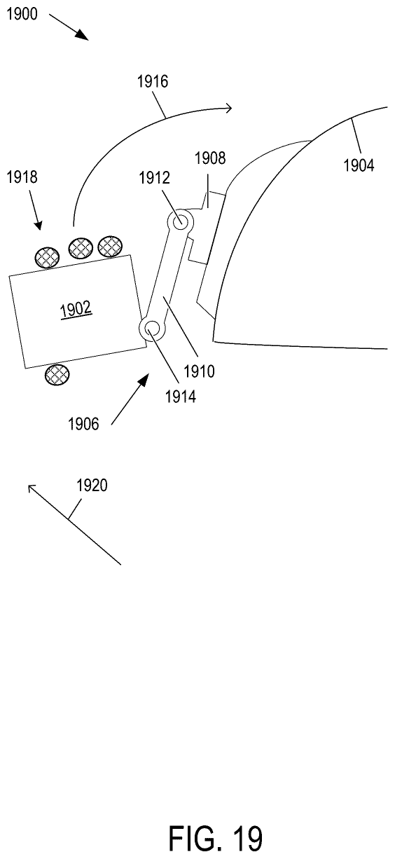

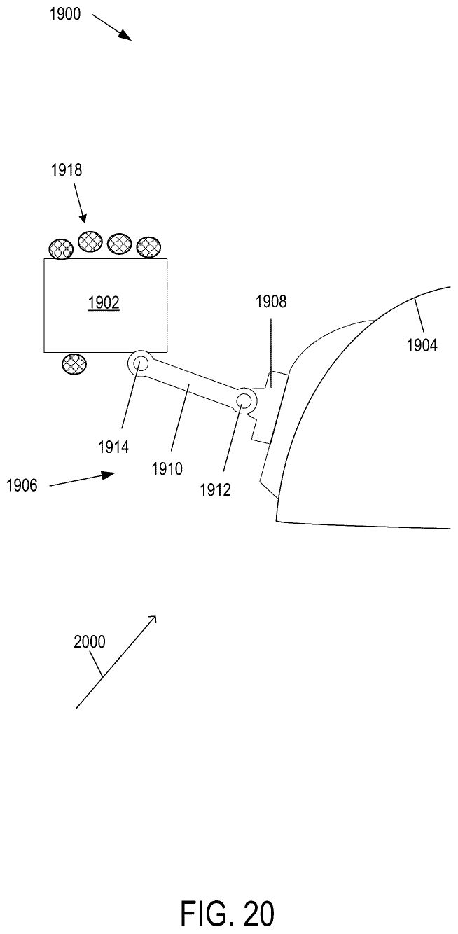

FIGS. 19-20 schematically depict an example HMD device 1900 traveling towards a transition point. Similar to HMD device 100, HMD device 1900 includes a head-up display 1902 that is mounted to a wearable support 1904 by a hinge assembly 1906. Hinge assembly 1906 includes a mounting component 1908 connected to wearable support 1904. Hinge assembly 1906 further includes a bar 1910 connected to mounting component 1908 at a first pivot 1912 and head-up display 1902 at a second pivot 1914. As described above, first pivot 1912 and/or second pivot 1914 can include one or more detents, friction mechanisms, interlocking features, and other structures described above.

Hinge assembly 1906 of FIG. 19 is shown in a deployed position. When hinge assembly 1906 moves towards a transition point to place head-up display 1902 in a stowed position, as indicated by 1916, movement of head-up display 1902 by fingers 1918 of a user may appear to stick at the transition point as schematically depicted in FIG. 20. To place head-up display 1902 in the stowed position, force on head-up display 1902 by fingers 1918 may change direction from a first direction 1920 below the transition point to a second direction 2000 at or near the transition point. This change of direction may disrupt movement of head-up display 1902 towards the stowed position. Thus, hinge assembly 1906 may appear to stick at the transition point. Further, a mechanical advantage along bar 1910 may be lower at the transition point than at other locations along first direction 1920. The lower mechanical advantage at the transition point of FIG. 20 may increase a difficulty for the user to move head-up display 1902 through the transition point.

Accordingly, a hinge assembly may employ a variable resistance mechanism that has less resistance through a transition point than other locations along a path of travel of a head-up display from a deployed position to a stowed position. Any pivot disclosed herein may utilize the variable resistance mechanism. Alternatively or additionally, a first pivot and a second pivot of the hinge assembly can be connected using gears and/or linkages such that the first pivot also rotates the second pivot. More specifically, the gears and/or linkages engage at and/or near the transition point such that rotation of a primary pivot (e.g., the pivot closer to a head, such as first pivot 1912) helps to rotate a secondary pivot (e.g., the pivot closer to a head-up display, such as second pivot 1914). The gears and/or linkages may not engage near the deployed position and/or the stowed position, in some examples. As a specific example, the gears can have shaped teeth and/or missing teeth to disengage the teeth at the stowed and/or deployed positions. Such configurations enable the two pivots to move independently to enable adjustment of the head-up display at or near the deployed and/or stowed positions, while helping to assist movement through the transition point. In some examples, one or more pivots of the hinge assembly may further comprise a spring biased such that a force of the spring helps to rotate the pivot through the transition point when the hinge assembly is moving upwards. In other examples, a spring-loaded mechanism, such as a spring-loaded toggle, may be integrated into the pivot to help snap the pivot through the transition point. The spring-loaded mechanism may help to move the pivot through the transition point when the hinge assembly is moving in an upward direction and/or a downwards direction. Example springs include an extension spring, a torsion spring, flat spring, or another suitable spring.

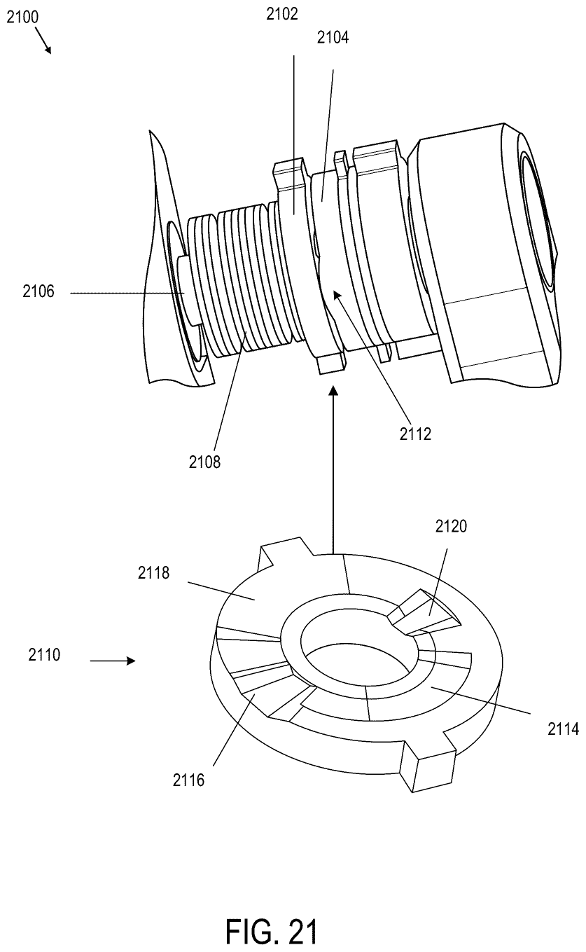

FIG. 21 depicts an example cam mechanism 2100 that utilizes a variable torque resistance. Cam mechanism 2100 is an example implementation of a variable resistance mechanism. Cam mechanism 2100 can be integrated into any pivot disclosed herein. Cam mechanism 2100 includes a first cam 2102 and a second cam 2104 that rotate relative to each other. First cam 2102 and second cam 2104 are mounted on a shaft 2106 with a disk spring 2108. First cam 2102 comprises a variable torque resistance 2110. Second cam 2104 includes a high-point 2112 that interfaces with variable torque resistance 2110. Disk spring 2108 applies a compressive force to first cam 2102 and second cam 2104 to engage high-point 2112 on second cam 2104 with variable torque resistance 2110 on first cam 2102. Within the context of a pivot by which two components of a hinge assembly are rotatably coupled, first cam 2102 is fixed to or forms part of a first component, and second cam 2104 is fixed to or forms part of a second component.

Variable torque resistance 2110 includes a first higher-friction zone 2114 corresponding to a deployed position of a hinge assembly. When high-point 2112 interfaces with first higher-friction zone 2114, a higher torque is generated in cam mechanism 2100. As first cam 2102 rotates relative to second cam 2104, variable torque resistance 2110 starts to taper to a lower-friction zone 2116, thus lowering a torque resistance with high-point 2112. Lower-friction zone 2116 corresponds to the transition point and may help to ease movement of the hinge assembly through the transition point. As first cam 2102 further rotates, variable torque resistance 2110 transition to a second higher-friction zone 2118, thereby increasing the torque resistance with high-point 2112. First cam 2102 further includes a detent 2120 to help hold the hinge assembly in a stowed position. In some examples detent 2120 can provide tactile and/or audible feedback to a user that the hinge assembly is in the stowed position. In other examples, detent 2120 may be omitted.

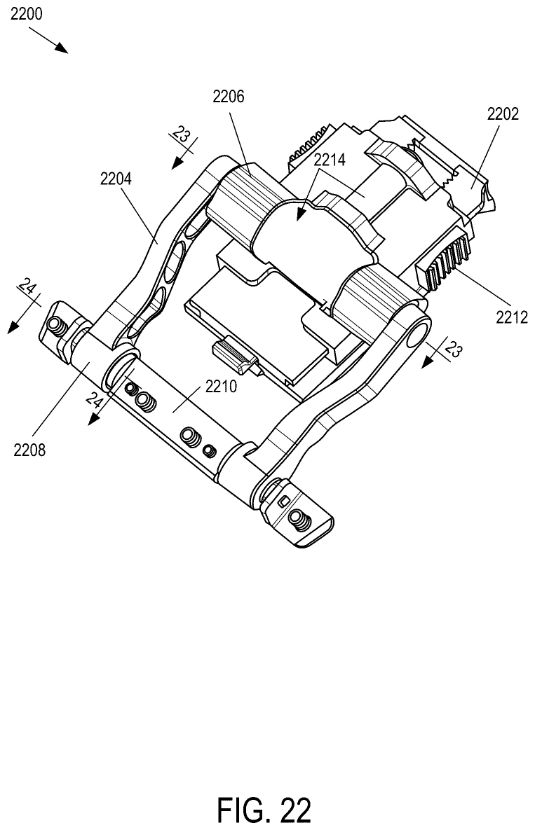

FIG. 22 depicts another example hinge assembly 2200 utilizing a bar and two pivots. Similar to hinge assembly 106, hinge assembly 2200 comprises a mounting component 2202 configured to connect to a wearable support. Hinge assembly further comprises a bar 2204 connected to mounting component 2202 at a first pivot 2206. Bar 2204 is also configured to connect to a head-up display at a second pivot 2208. In the depicted example, a connector 2210 of second pivot 2208 is connectable to the head-up display. As described above, first pivot 2206 and/or second pivot 2208 can include one or more detents, a friction mechanism, interlocking features, and/or other structures described above. Further, first pivot 2206 and/or second pivot 2208 can be configured in any suitable manner disclosed herein.

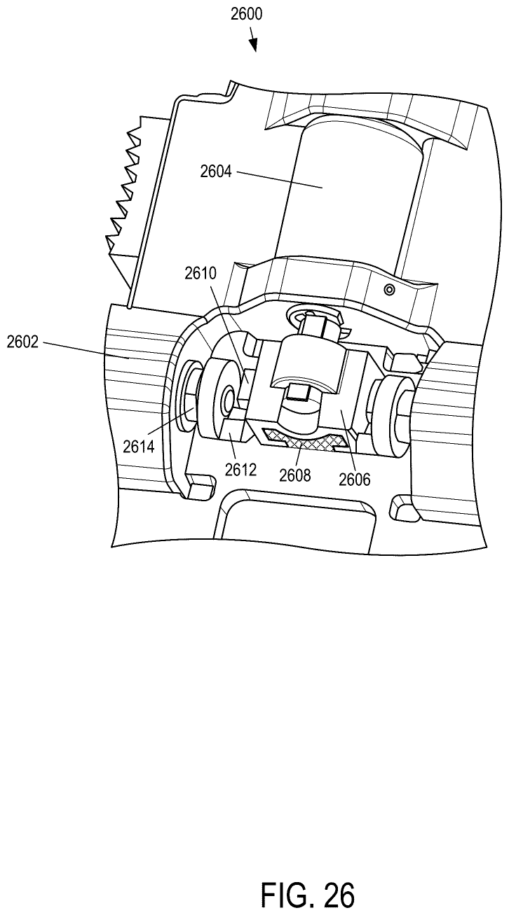

Similar to hinge assembly 106, hinge assembly 2200 further comprises an adjustment mechanism 2212 to adjust a position of first pivot 2206 relative to mounting component 2202. Such an adjustment may help to align the head-up display with eyes of an user. Adjustment mechanism 2212 can be configured in any manner as disclosed herein. Hinge assembly 2200 further comprises an adjustable stopper 2214. Adjustable stopper 2214 is configured to adjust an angular location of a hard-stop relative to a rotational axis of first pivot 2206, and thereby adjusting a location to hold a head-up display, such as in a deployed position. An example adjustable stopper is discussed with reference to FIG. 26. In such a manner, the deployed position can be configured for an individual user and be repeatable.

As mentioned above, hinge assembly 2200 can be configured to retain a head-up display in a stowed position, a first deployed position or a second deployed position. As such, hinge assembly 2200 is configured to move along a first path of travel from the first and/or second deployed positions to the stowed position. Hinge assembly 2200 also moves along a second path of travel from the stowed position to the first and/or second deployed positions. As discussed above with reference to FIGS. 19-20, a hinge assembly moving between a stowed position and a deployed position may apparently stick at a transition point. As such, first pivot 2206 and second pivot 2208 comprise a corresponding variable resistance mechanism that has less resistance through a transition point than other locations along one or more of the first path of travel and the second path of travel.

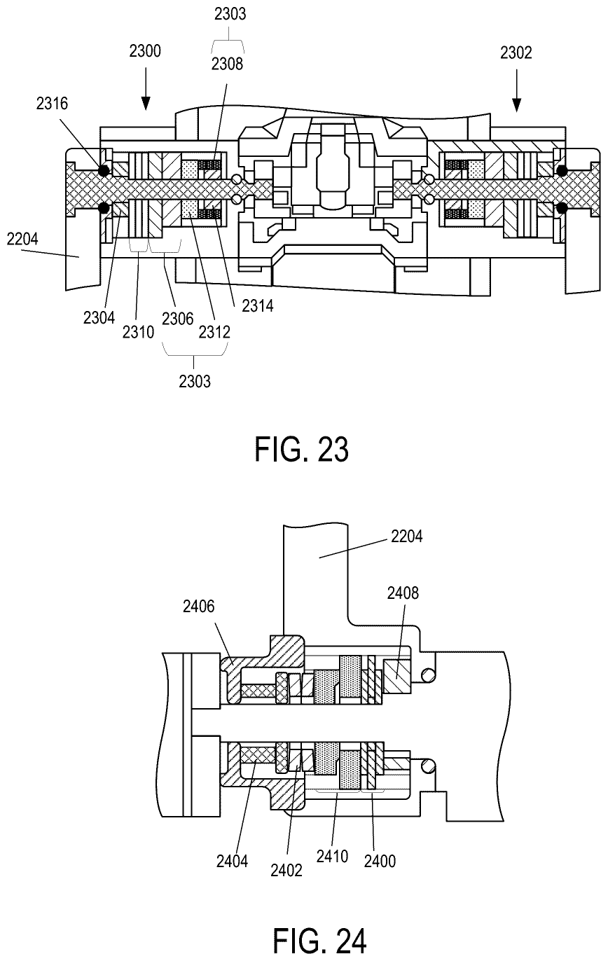

FIG. 23 schematically depicts first pivot 2206 taken along line 23-23 of FIG. 22. In the depicted example, first pivot 2206 has a first side 2300 and a second side 2302 that are mirrors of each other. For simplicity, first pivot 2206 is discussed with reference to first side 2300. However, it will be understood that second side 2302 comprises the same components as first side 2300.

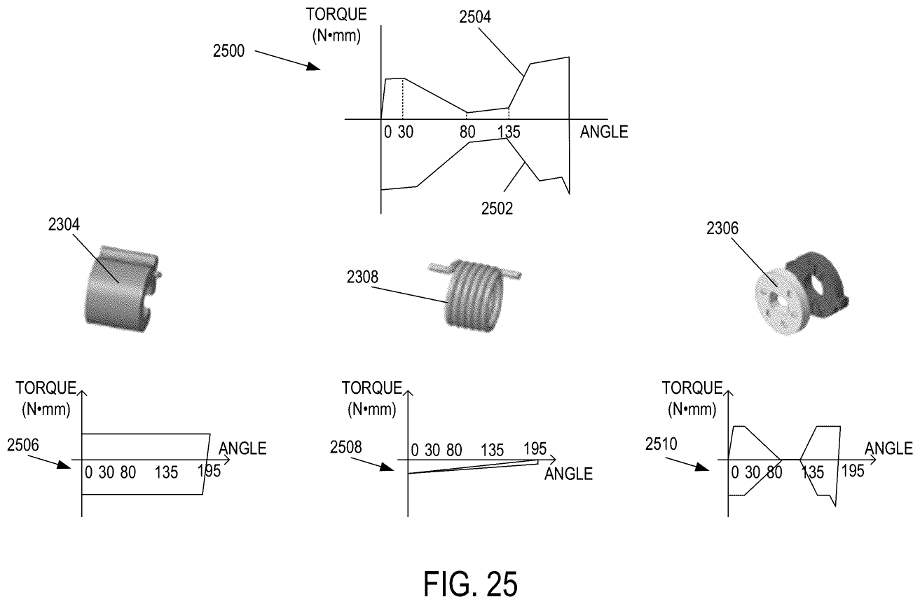

First pivot 2206 comprises a variable resistance mechanism 2303 that has less resistance through a transition point than other locations along one or more of the first path of travel and the second path of travel. Further, the variable resistance mechanism 2303 is configured to have different resistance profiles for the first path and the second paths of travel. An example torque profile for first pivot 2206 is discussed in more detail with reference to FIG. 25.

In the example of FIG. 23, the variable resistance mechanism 2303 comprises a friction collar 2304, a cam mechanism 2306, and a torsion spring 2308. Similar to cam mechanism 2100, cam mechanism 2306 comprises a first cam having higher-friction and lower-friction zones. Further, cam mechanism 2306 also comprises a second cam having a high-point that interfaces with the higher-friction and lower-friction zones of the first cam. When the first and second cams of cam mechanism 2306 engage, a variable torque resistance is generated. First pivot 2206 further comprises friction washers 2310 to provide friction to rotation of bar 2204 relative to mounting component 2202. More specifically, a portion of friction washers 2310 are keyed to bar 2204 and a remainder of friction washers 2310 are keyed to mounting component 2202. Disk springs 2312 provide a compressive force to engage friction washers 2310 and engage cam mechanism 2306. A nut 2314 is configured to adjust the compressive force provided by disk springs 2312. In some examples, nut 2314 is adjusted during an assembly process of first pivot 2206. First pivot 2206 further comprises a rubber gasket 2316 configured to seal first pivot 2206. Rubber gasket 2316 helps to prevent foreign matter from entering first pivot 2206. FIG. 23 is illustrative. In other examples, a first pivot can take other forms.

FIG. 24 schematically depicts second pivot 2208 taken along line 24-24 of FIG. 22. Similar to first pivot 2206, second pivot 2208 comprises friction washers 2400, disk springs 2402, a nut 2404, and a gasket 2406. Second pivot 2208 also includes a variable resistance mechanism that has less resistance through a transition point than other locations along one or more of the first path of travel and the second path of travel. In contrast to the variable resistance mechanism 2303 of first pivot 2206, the variable resistance mechanism of second pivot 2208 comprises a friction collar 2408 and a cam mechanism 2410. Cam mechanism 2100 can be used for cam mechanism 2410. FIG. 24 is illustrative. In other examples, a second pivot can take other forms.

FIG. 25 illustrates an example torque profile 2500 of the variable resistance mechanism 2303 of first pivot 2206 of FIGS. 22-23. As shown, torque profile 2500 has a first resistance profile 2502 for the first path of travel of hinge assembly 2200, and a second resistance profile 2504 for the second path of travel of hinge assembly 2200. First resistance profile 2502 and second resistance profile 2504 help to bias movement of hinge assembly 2200 against gravity and towards the stowed position. Such a biased movement can help to count a weight of head-up display connected to hinge assembly 2200.

Torque profile 2500 includes a first portion profile 2506, a second portion profile 2508, and a third portion profile 2510. Such a configuration can help to reach desired peak and low torque values in torque profile 2500 across multiple hinge assemblies. As shown, friction collar 2304 is configured to generate first portion profile 2506 having a generally uniform torque profile for each of the first path and the second path of hinge assembly 2200. As shown, first portion profile 2506 has different torque values along one of the first path or the second path than the other of the first path or the second path. First portion profile 2506 can help to provide a general resistance to the angular movement of first pivot 2206. Next, torsion spring 2308 is configured to generate second portion profile 2508 that biases movement of first pivot 2206 opposite of gravity and towards the stowed position of hinge assembly 2200. Second portion profile 2508 can help to counteract a weight of a head-up display connected to hinge assembly 2200. Next, cam mechanism 2306 is configured to generate third portion profile 2510 having variable torque resistance along the first path of travel and the second path of travel. Third portion profile 2510 can help move hinge assembly 2200 through a corresponding transition point along the first path of travel and the second path of travel, as discussed above. In other examples, torsion spring 2308 and corresponding second portion profile 2508 may be omitted. While discussed herein in the context of first pivot 2206, a resistance torque profile may be used by any suitable pivot disclosed herein. FIG. 25 is illustrative. In other examples, another suitable torque profile may be used.

As discussed above, an adjustable stopper may be used to adjust a location of a deployed position of a hinge assembly. FIG. 26 schematically depicts an example adjustable stopper 2600. Adjustable stopper 2600 is an example implementation of adjustable stopper 2214. Adjustable stopper 2600 is configured to adjust a location that restricts angular movement of a pivot 2602. As shown, adjustable stopper 2600 comprises a control knob 2604, a slider 2606, and a rail 2608. Control knob 2604 is configured to adjust a position of slider 2606 by translation along rail 2608. Slider 2606 comprises a hard-stop 2610 that is keyed to slider 2606. In some examples, slider 2606 and hard-stop 2610 may be formed as one piece. In other examples, hard-stop 2610 may be formed independently and then affixed to slider 2606, such as by welding, for example. Adjustable stopper 2600 further comprises a friction collar 2612. Friction collar 2612 is keyed to a shaft 2614. When friction collar 2612 impacts hard-stop 2610, angular movement of a shaft 2614 is restricted. In such a manner, adjustable stopper 2600 enables a location of a deployed position of a hinge assembly to be adjusted for different users while enabling a set deployed position for a single user to be repeatable. FIG. 26 is illustrative. In other examples, an adjustable stopper may take other forms.

As previously mentioned, a first angular adjustment of a pivot between a stowed position and a deployed position can use a separate control mechanism than a second angular adjustment of the pivot between a first deployed position and a second deployed position. FIG. 27 schematically depicts an example pivot 2700 utilizing a tilt mechanism 2702 as the separate control mechanism. Pivot 2700 is an example implementation of pivot 514. Similar to pivot 514, pivot 2700 allows rotational movement of a bar 2704 relative to a mounting component 2706. Specifically, pivot 2700 comprises a main shaft 2708 that allows movement between a deployed position and a stowed position for bar 2704. Pivot 2700 further comprises a cam 2710 keyed to main shaft 2708. Cam 2710 comprises a hard-stop configured to restrict angular movement of pivot 2700 when the hard-stop engages with a corresponding feature on bar 2704, such as in the deployed position, for example. In some examples, the hard-stop can comprise hills and valleys that interact with the corresponding feature of bar 2704. As an example, variable torque resistive 2110 of FIG. 21 has hills and valleys. Pivot 2700 further comprises a spring 2712 that provides a compressive force to engage cam 2710 with bar 2704. As shown, pivot 2700 further comprises a nut 2714 configured to adjust torque on cam 2710.

Tilt mechanism 2702 is configured to allow the second angular adjustment of pivot 2700 between the first deployed position and the second deployed position. Specifically, tilt mechanism 2702 adjusts an angular position of the hard-stop of cam 2710 relative to a rotational axis of pivot 2700. Tilt mechanism 2702 comprises a control mechanism in the form of a control lever 2716. Control lever 2716 is configured to rotate around a secondary shaft 2718. As control lever 2716 rotates around secondary shaft 2718, a linkage 2720 transfers rotational movement to main shaft 2708. When main shaft 2708 rotates, cam 2710 also rotates relative to a rotational axis of main shaft 2708. In such a manner, a location of the hills and valleys of cam 2710 can be adjusted by angular movement relative to a rotational axis of pivot 2700. This changes the location where bar 2704 is held for the deployed position, and thus allowing movement between the first deployed position and the second deployed position. Tilt mechanism 2702 further comprises a frictional torque in the form of friction washers 2722. Friction washers 2722 are configured to provide resistance to the rotational movement of control lever 2716 relative to secondary shaft 2718. Such a configuration can help to reduce an accidental movement of pivot 2700. In the depicted example, a portion of friction washers 2722 are connected to secondary shaft 2718 and a remainder of friction washers 2722 are connected to control lever 2716. FIG. 27 is illustrative. In other examples, pivot 2700 may comprise additional components not illustrated and/or omit components depicted.

FIG. 28 depicts another view of tilt mechanism 2702. Tilt mechanism 2702 comprises an eccentric pin 2800 connected to control lever 2716. As control lever 2716 rotates, eccentric pin 2800 moves within a slot 2802 of linkage 2720, thereby rotating linkage 2720. Further, linkage 2720 is configured to engage with main shaft 2708 such that the rotation of linkage 2720 is transferred to main shaft 2708. In such a manner, tilt mechanism 2702 allows movement of pivot 2700 between a first deployed position and a second deployed position while using a smaller area than separate pivots to move between the stowed position, the first deployed position, and the second deployed position.

The hinge assemblies disclosed herein comprise various moving components. Mechanical clearances between the various moving components may result in undesired free movement of a hinge assembly, generally referred to as backlash movement. Accordingly, any suitable interface between the various moving components of the hinge assembly can comprise one or more adjustment features. As an example, an adjustment feature can comprise an interference fit, such as scallop cuts, for example, to help tighten up the mechanical clearances. The scallop cuts can help to reduce pressure between components that move, and thus frictional force. Yet as another example, a slider adjustment mechanism can comprise one or more gibs to generate tight tolerances and reduce backlash movement. Specifically, the gib can comprise one or more tapered components that interface with each other to reduce a distance between two components of the hinge assembly. In some examples, the gib is adjustable, such as with adjustment screws, for example. The gib can be adjusted as a factory setting and/or in the field. As a further example, an adjustment mechanism that comprises interlocking features can further comprise an anti-backlash nut to reduce backlash movement. In other examples, any other suitable adjustment feature that tightens up mechanical clearances may be used with any moving component disclosed herein. It will be understood that the example adjustment features disclosed herein are provided for illustrative purposes as other suitable adjustment features may be used to tighten up mechanical clearances and reduce backlash movement.

Another example provides a head-mounted display device, comprising a wearable support configured to be worn on a head of a user, and a head-up display mounted to the wearable support by a hinge assembly, the hinge assembly comprising a mounting component connected to the wearable support, and a bar connected to the mounting component at a first pivot and connected to the head-up display at a second pivot. In some such examples, one or more of the first pivot and the second pivot alternatively or additionally comprises a corresponding variable resistance mechanism that has less resistance through a transition point than other locations along one or more of a first path of travel of the head-up display and a second path of travel of the head-up display, the first path of travel being from a deployed position to a stowed position, and the second path of travel being from the stowed position to the deployed position. In some such examples, the first path of travel alternatively or additionally has a different resistance profile than the second path of travel. In some such examples, the variable resistance mechanism alternatively or additionally comprises a corresponding friction collar configured to generate a portion of a variable torque resistance. In some such examples, the variable resistance mechanism alternatively or additionally comprises a corresponding cam mechanism configured to generate a portion of a variable torque resistance. In some such examples, the variable resistance mechanism of the first pivot alternatively or additionally comprises a torsion spring configured to generate a portion of a variable torque resistance. In some such examples, the torsion spring is alternatively or additionally configured to bias movement of the first pivot opposite of gravity. In some such examples, the head-mounted display device alternatively or additionally comprises an adjustable stopper that allows a position of a hard-stop on the first pivot to be adjusted. In some such examples, the hinge assembly alternatively or additionally comprises an adjustment mechanism that allows a position of the first pivot relative to the mounting component to be adjusted.

Another example provides a head-mounted display device, comprising a wearable support configured to be worn on a head of a user, and a head-up display mounted to the wearable support by a hinge assembly, the hinge assembly comprising a mounting component connected to the wearable support, a first bar connected to the mounting component at a first pivot, and a second bar attached to the first bar at a second pivot and attached to the head-up display. In some such examples, one or more of the first pivot and the second pivot alternatively or additionally comprises a variable torque resistance. In some such examples, the one or more of the first pivot and the second pivot alternatively or additionally comprises a corresponding one or more of a friction collar, cam mechanism, or a torsion spring configured to generate at least a portion of the variable torque resistance. In some such examples, the head-mounted display device alternatively or additionally comprises an adjustable stopper that allows a position of a hard-stop on the first pivot to be adjusted. In some such examples, one or more of the first pivot and the second pivot alternatively or additionally comprises one or more detents. In some such examples, the hinge assembly alternatively or additionally comprises an adjustment mechanism that allows a position of the first pivot relative to the mounting component to be adjusted.

Another example provides a head-mounted display device, comprising a wearable support configured to be worn on a head of a user, and a head-up display mounted to the wearable support by a hinge assembly, the hinge assembly comprising a mounting component connected to the wearable support, a bar connected to the mounting component at a pivot and connected to the head-up display, a first adjustment mechanism that allows a position of the pivot relative to the mounting component to be adjusted, and a second adjustment mechanism that allows a position of the head-up display relative to the bar to be adjusted. In some such examples, the pivot alternatively or additionally comprises a tilt mechanism that allows movement between a first deployed position and a second deployed position of the head-up display. In some such examples, the pivot alternatively or additionally comprises one or more hard-stops to restrict angular movement of the pivot, and wherein an angular position of the one or more hard-stops relative to a rotational axis of the pivot is adjustable. In some such examples, the tilt mechanism alternatively or additionally comprises an eccentric pin and a control mechanism connected to the eccentric pin, the control mechanism comprising a frictional torque. In some such examples, one or more of the first adjustment mechanism and the second adjustment mechanism alternatively or additionally comprises interlocking features to restrict movement of the corresponding mechanism when engaged.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-mounted display device, comprising:
a wearable support configured to be worn on a head of a user; and
a head-up display mounted to the wearable support by a hinge assembly, the hinge assembly comprising:
a mounting component connected to the wearable support, and
a bar connected to the mounting component at a first pivot and connected to the head-up display at a second pivot.

2. The head-mounted display device of claim 1, wherein one or more of the first pivot and the second pivot comprises a corresponding variable resistance mechanism that has less resistance through a transition point than other locations along one or more of a first path of travel of the head-up display and a second path of travel of the head-up display, the first path of travel being from a deployed position to a stowed position, and the second path of travel being from the stowed position to the deployed position.

3. The head-mounted display device of claim 2, wherein the first path of travel has a different resistance profile than the second path of travel.

4. The head-mounted display device of claim 2, wherein the variable resistance mechanism comprises a corresponding friction collar configured to generate a portion of a variable torque resistance.

5. The head-mounted display device of claim 2, wherein the variable resistance mechanism comprises a corresponding cam mechanism configured to generate a portion of a variable torque resistance.

6. The head-mounted display device of claim 2, wherein the variable resistance mechanism of the first pivot comprises a torsion spring configured to generate a portion of a variable torque resistance.

7. The head-mounted display device of claim 6, wherein the torsion spring is configured to bias movement of the first pivot opposite of gravity.

8. The head-mounted display device of claim 1, further comprising an adjustable stopper that allows a position of a hard-stop on the first pivot to be adjusted.

9. The head-mounted display device of claim 1, wherein the hinge assembly further comprises an adjustment mechanism that allows a position of the first pivot relative to the mounting component to be adjusted.

10. A head-mounted display device, comprising:
a wearable support configured to be worn on a head of a user; and
a head-up display mounted to the wearable support by a hinge assembly, the hinge assembly comprising:
a mounting component connected to the wearable support,
a first bar connected to the mounting component at a first pivot, and
a second bar attached to the first bar at a second pivot and attached to the head-up display.

11. The head-mounted display device of claim 10, wherein one or more of the first pivot and the second pivot comprises a variable torque resistance.

12. The head-mounted display device of claim 11, wherein the one or more of the first pivot and the second pivot comprises a corresponding one or more of a friction collar, cam mechanism, or a torsion spring configured to generate at least a portion of the variable torque resistance.

13. The head-mounted display device of claim 10, further comprising an adjustable stopper that allows a position of a hard-stop on the first pivot to be adjusted.

14. The head-mounted display device of claim 10, wherein one or more of the first pivot and the second pivot comprises one or more detents.

15. The head-mounted display device of claim 10, wherein the hinge assembly further comprises an adjustment mechanism that allows a position of the first pivot relative to the mounting component to be adjusted.

16. A head-mounted display device, comprising:
a wearable support configured to be worn on a head of a user; and
a head-up display mounted to the wearable support by a hinge assembly, the hinge assembly comprising:
a mounting component connected to the wearable support,
a bar connected to the mounting component at a pivot and connected to the head-up display,
a first adjustment mechanism that allows a position of the pivot relative to the mounting component to be adjusted; and
a second adjustment mechanism that allows a position of the head-up display relative to the bar to be adjusted.

17. The head-mounted display device of claim 16, wherein the pivot comprises a tilt mechanism that allows movement between a first deployed position and a second deployed position of the head-up display.

18. The head-mounted display device of claim 17, wherein the pivot comprises one or more hard-stops to restrict angular movement of the pivot, and wherein an angular position of the one or more hard-stops relative to a rotational axis of the pivot is adjustable.

19. The head-mounted display device of claim 18, wherein the tilt mechanism comprises an eccentric pin and a control mechanism connected to the eccentric pin, the control mechanism comprising a frictional torque.

20. The head-mounted display device of claim 16, wherein one or more of the first adjustment mechanism and the second adjustment mechanism comprises interlocking features to restrict movement of the corresponding mechanism when engaged.
